(19) United States
(12) Patent Application Publication
(10) Pub. No.: US 2013/0133380 A1
(43) Pub. Date: May 30, 2013

(54) SECURITY DEVICE WITH FLEXIBLE ATTACHMENT

(71) Applicant: Adam Mark Will, Fort Mill, SC (US)

(72) Inventor: Adam Mark Will, Fort Mill, SC (US)

(73) Assignee: CHECKPOINT SYSTEMS, INC., Philadelphia, PA (US)

(21) Appl. No.: 13/305,848

(22) Filed: Nov. 29, 2011

(51) Int. Cl. E05B 73/00; G09F 3/00

(52) U.S. Cl. 70/15; 40/299.01

(57) ABSTRACT

A system and method for preventing wardrobing is presented. An anti-wardrobing device for attachment to a merchandise item includes a ribbon, a branding plate and a lock. The ribbon has a first end and a second end adapted to be placed through the merchandise item. The branding plate is adapted to display information about the merchandise item, branding of merchandise item. The lock is located at one end of the branding plate. The lock is adapted to be locked to the ribbon so that the ribbon is looped through the merchandise item and then locked so that the ribbon cannot be removed from the merchandise item without cutting the ribbon.

### BACKGROUND OF THE INVENTION

1. Field of Invention

The present invention relates generally to an apparatus, system and method for the display of merchandise in a retail setting. More particularly, the apparatus, system and method relates to preventing a customer from returning a merchandise item after it has been purchased and used in a practice known as wardrobing. Specifically, the apparatus, system and method provides for attaching a flexible attachment to a merchandise item so that if the attachment is removed, use of the item is detected.

2. Description of Related Art

In the retail environment merchants desire displaying merchandise items so that consumers can view the items. In the case of clothing or jewelry, it is desirable to have a potential purchaser have the ability to try on the item before purchasing it in order to further increase the probability that the consumer will purchase that item. However, a problem exists that a consumer will purchase an item such as a dress, remove any labeling, then wear the dress one time, reattach the labeling and return the dress for a full refund.

A variety of security devices can be attached to merchandise items to prevent their theft. However, these security devices are generally removed at the time of purchase before the item leaves the store because they are of sufficient value and/or can be reused. For example, wrap type protection devices are often used to protect electronic products. Wrap protection devices have a housing with a ratchet mechanism that allows cables to be wrapped about a merchandise item and are tightened around the item. Alarms are generated by the housing if the item is brought near an entrance of the store. Wrap devices are of sufficient cost so they are removed at the time of the purchase of the item they are protecting. A better way is needed to protect merchandise items and to prevent their anti-wardrobing return after purchase.

### SUMMARY OF THE INVENTION

The preferred embodiment of the invention includes an anti-wardrobing device for attachment to a merchandise item. The anti-wardrobing device includes a ribbon, a branding plate and a lock. The ribbon has a first end and a second end adapted to be placed through the merchandise item. The branding plate is adapted to display information about the merchandise item and branding of the merchandise item. The lock is located at one end of the branding plate. The lock is adapted to be locked to the ribbon so that the ribbon is looped through the merchandise item and the lock so that the ribbon cannot be removed from the merchandise item without cutting the ribbon.

### BRIEF DESCRIPTION OF SEVERAL VIEWS OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates a preferred embodiment of an anti-wardrobing device attached to an item of merchandise.

FIG. 2 illustrates a top perspective view of the preferred embodiment of the anti-wardrobing device.

FIG. 3 illustrates a bottom perspective view of the preferred embodiment of the anti-wardrobing device.

FIG. 4 illustrates another bottom view of the preferred embodiment of the anti-wardrobing device.

FIG. 5 illustrates a cross-sectional view of the preferred embodiment of the anti-wardrobing device.

FIG. 6 illustrates a cross-sectional view of the preferred embodiment of the lock housing.

FIG. 7 illustrates another cross-sectional view of the preferred embodiment of the lock housing.

FIG. 8 illustrates a bottom perspective view of the preferred embodiment of the anti-wardrobing device.

FIG. 9 illustrates another perspective view of a second configuration of the preferred embodiment of the anti-wardrobing device in a locked position.

FIG. 10 illustrates a perspective view of a second configuration of the preferred embodiment of the anti-wardrobing device in an unlocked position.

FIG. 11 illustrates an embodiment of a method using the preferred embodiment as an anti-wardrobing device.

Similar numbers refer to similar parts throughout the drawings.

### DETAILED DESCRIPTION

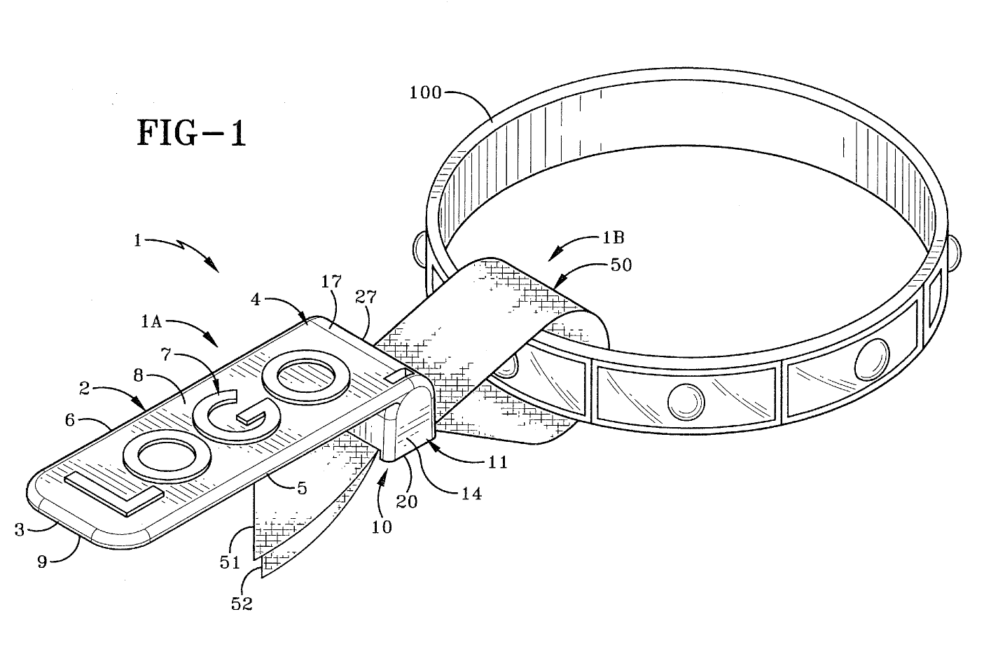

FIG. 1 illustrates the preferred embodiment of a security device 1 that is useful in the prevention of returning a merchandise item 100 after it has been purchased and used or worn (referred to as wardrobing). The security device 1 includes a solid portion 1A and a flexible portion 1B. The solid portion includes a lock device 10 and a brand plate 2. The flexible portion can be a ribbon 50. The ribbon 50 has a first end 51 and a second end 52. Ribbon 50 is placed through merchandise item 100 and rigid portion 1A is locked onto the ribbon 50. Now, if the buyer removes or attempts to remove security device 1 after purchase, its removal will be noticed and no refund will be given to the consumer. Ideally, the only way to remove security device 1 is to destroy device 1 or cut the ribbon 50, an occurrence the merchant will recognize upon its return. Ribbon 50 (flexible portion 1B) can be any flexible material such as fabric, lanyards, or other material with sufficient width to locked into the rigid device 1A as understood by those of ordinary skill in the art. Similarly, the ribbon can be any color, have any pattern displayed on it, repeatedly display a trademark or any other pattern, or information as desired.

Lock device 10 can be formed of a polymer or another material. In the preferred embodiment, device 10 will be rigid so that it cannot be deformed or it will be brittle so that if one does attempt to tamper with it, it will break apart and it will obvious that is has been tampered with. This would ensure that the security device 1 could not be taken apart and reassembled without its reassembly being detected. In the preferred embodiment, lock device 10 is formed with both a rigid material that significantly prevents deformation of the lock device 10 and somewhat easily breaks apart when tampered with.

Lock device 10 is formed adjacent a brand plate 2. Brand plate 2 has a left end 3, a right end 4, a front side 5, and a back side 6 as well as a top 8 and a bottom 9. In the preferred embodiment, a label 7 is imprinted onto the top 8 of the brand plate 2. In the Figures, brand plate 2 is shown as an elongated rectangle, however brand plate 2 can be any shape and of sufficient size to display the label 7. Label 7 can be any branding symbol, trademark information, information associated with the merchandise item 100 the security device 1 is adapted to be attached to or any other information a purchaser of merchandise item 100 may be interested in. Label 7, brand plate 2 and ribbon 50 can be different colors and have any color scheme that is desired. Additionally, a warning such as “cannot be returned if removed” or the like can also be marked on the top 8 and/or bottom 9 of the brand plate 2.

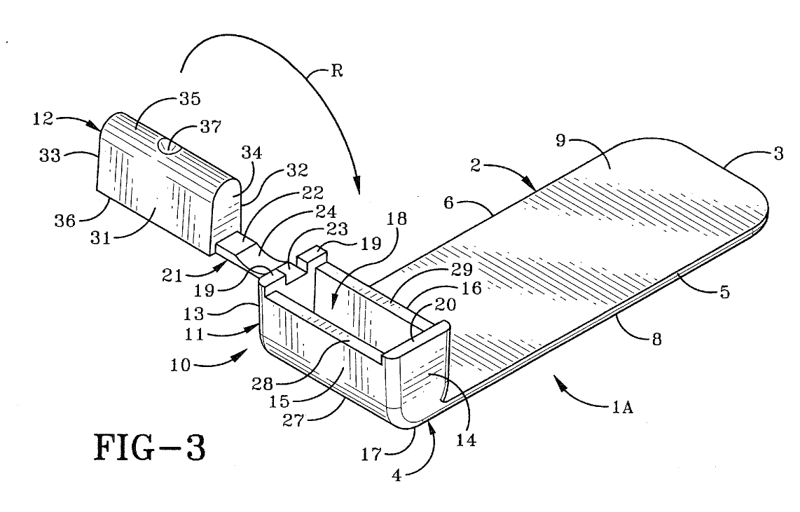

As best seen in FIG. 3, lock device 10 is formed with a lock housing 11 and a lock insert 12. In the preferred embodiment, lock housing 11 is formed with a left side 13, a right side 14, a front side 15, a back side 16 and a bottom side 17. Bottom side 17 is at least partially formed where brand plate 2 merges with and becomes part of the lock housing 11. The bottom side 17 is curved at edge 27 where it intersects front side 15. These walls form a generally rectangular-shaped chamber 18. Left side 13 further includes a pair of left lips that project upwards above top edges 28 and 29 of the front side 15 and the back side 16 of the lock housing 11. Right side 14 includes a right lip 20 that is also projected above the top edges 28 and 29 of the front side 15 and the back side 16 of the lock housing 11 that runs continuously between the front side 15 and the back side 16.

As best illustrated in FIG. 4, inside the chamber 18, the bottom side 18 is formed with a protrusion 25 that is preferably formed with a point at its tip. As best seen in FIGS. 6 and 7, right side 14 is formed with a tab 44 on its inside surface 47 facing chamber 18. Tab 44 is generally tapered from the inside surface 47 of the right side 14 so that it forms a ledge 45 projecting from the inside surface 47.

As best seen in FIG. 4, lock insert 12 is connected to the lock housing 11 with a connector 21. In the preferred embodiment, these components are formed of one continuous piece of plastic material. Connector 21 includes a left end 22, a center portion 24 and a right end 23. In the preferred embodiment and best seen in FIG. 3, center portion 24 is thinner at its center than where it intersects the left end 22 and the right end 23.

Lock insert 12 is attached to connector 21 at the connector's left end 22. Lock insert 12 is formed with a front side 31, a back side 32, a left side 33, a right side 34, a top 35 and a bottom 36. The lock insert 12 is generally rectangular in shape and its top is generally rounded. The lock insert 12 is sized so that it fits into the complementary chamber 18 of lock housing 11. A lock insert cavity 37 is formed in the top 35 of lock insert 12 for receiving the protrusion 25 of lock housing 11.

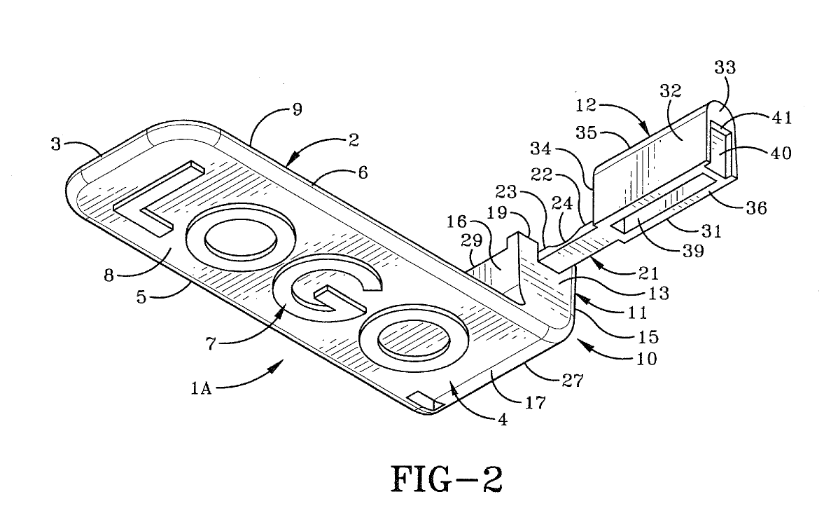

As best seen in FIG. 2, lock insert 12 further includes a partial channel 40 formed in the left side 33. Channel 40 begins at the bottom 36 and extends partially across the left side 33 until it terminates to form a ridge 41. In the preferred embodiment, lock insert 12 is formed with an opening 39 that opens on the bottom. This opening 39 gives lock insert 12 a small amount of flexibility.

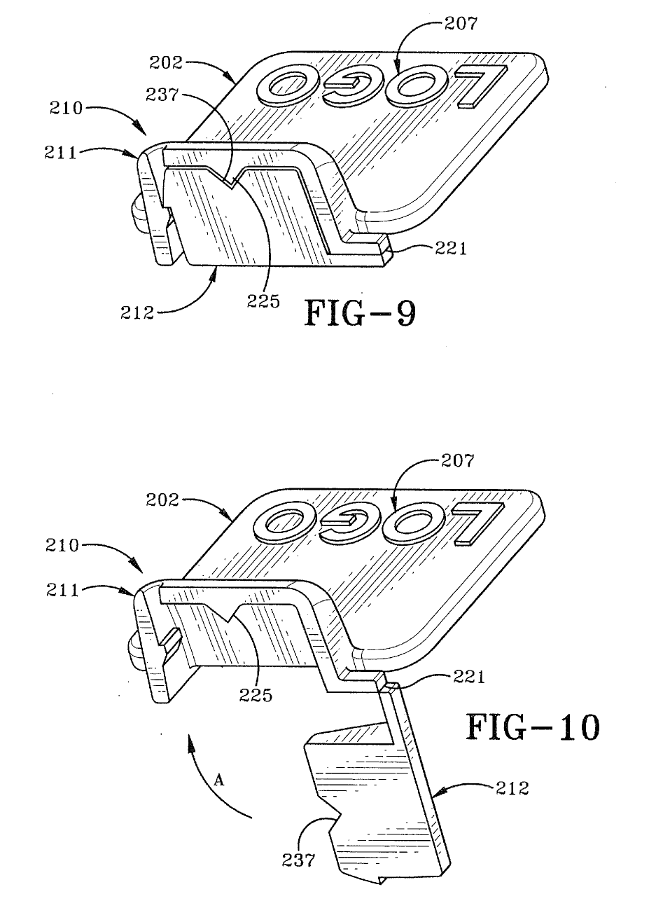

A second configuration of the preferred embodiment is shown in FIGS. 9 and 10. Similar to the first embodiment, this embodiment includes a lock device 210, branding plate 202 with a label 207 printed on one of its surfaces. The lock device 210 also includes a lock housing 211 and a lock insert 212 that is inserted into the lock housing 211. This configuration also includes a barb 225 that fits into a complementary shaped notch 237 in the lock insert 212. Barb 225 is ideally pointed and sharp enough to dig into the ribbon when lock device 210 is locked. Any attempt to the pull ribbon out of the lock device 210 will result in the barb 225 tearing the ribbon and it will easily be detected that an attempt to remove the security device was made.

Having described the components and characteristics of the security devices, its functionality will now be described with reference to a method of using the security device. Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

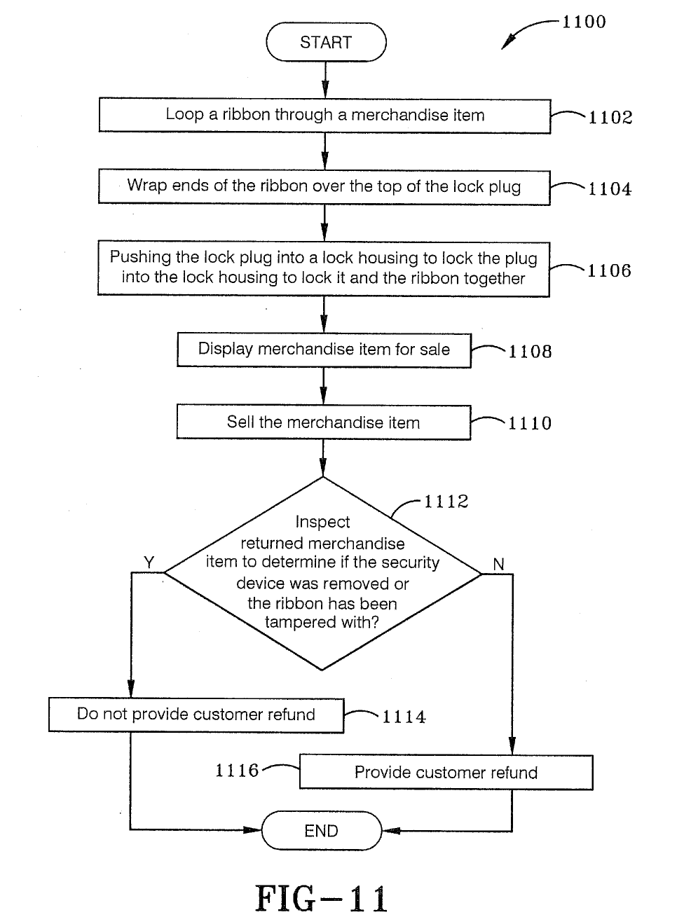

FIG. 11 illustrates a method merchandise item 1100 of locking the security device 1 onto a merchandise item such as jewelry or clothing to prevent wardrobing (the wearing of the item one time then attempting to return the item for a full refund). The method begins by looping ribbon 50 through the merchandise item 100, at 1102. The ends of the ribbon are then wrapped around the top 35, front side 31 and back side 32 of the lock insert 12, at 1104. The amount of excess ribbon between the first and second ends 51, 52 and the lock insert can be variable depending on the size of the merchandise item 100 and how it is displayed.

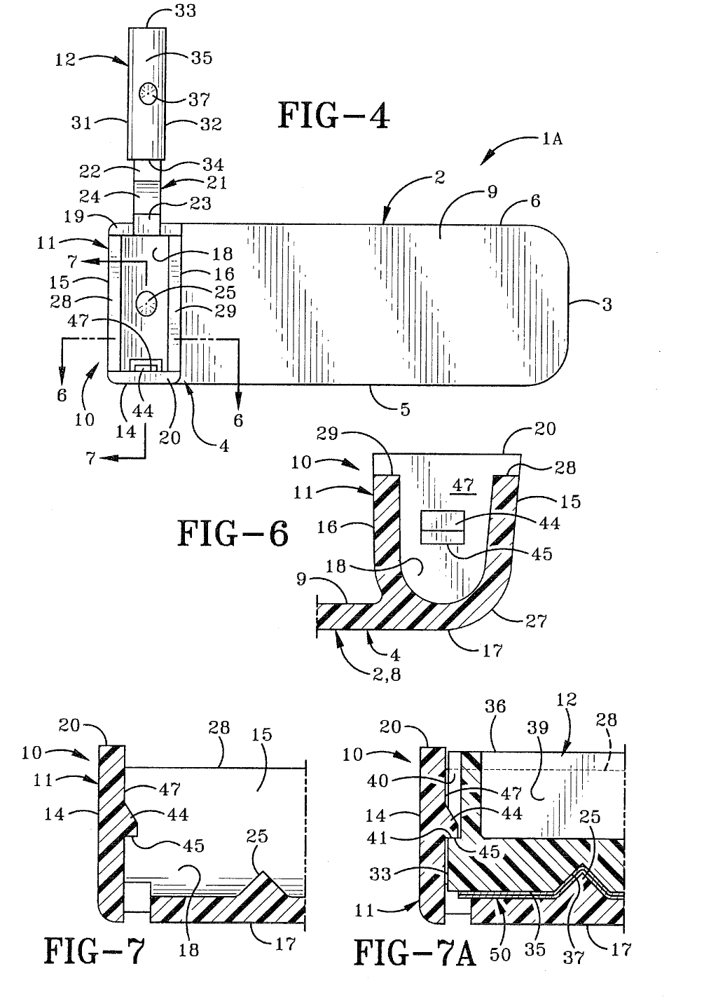

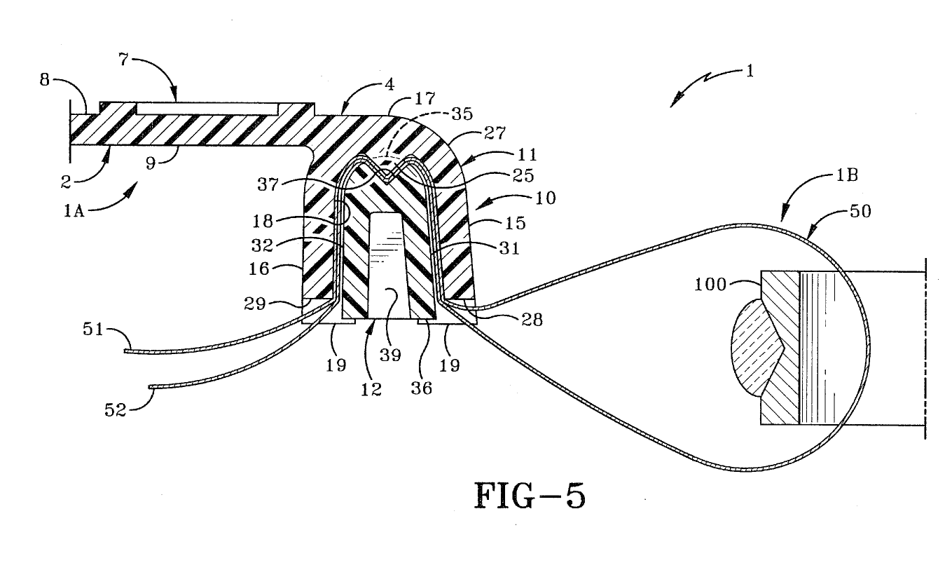

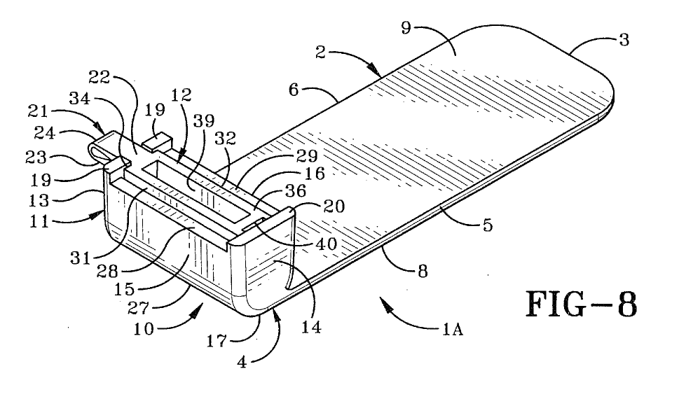

Connector 21 acts as a living hinge and is best viewed in FIG. 3. It allows lock insert 12 to be rotated in the direction of Arrow R so that lock insert 21 can be slid into chamber 18 of the lock housing. The corresponding rotation for the second embodiment is shown by Arrow A in FIG. 10. With ribbon 50 wrapped over the top 35, front side 31 and back side 32 of the lock insert 12, the lock insert 12 is snapped into a locked position into the lock chamber 18, at 1106. The cross-sectional view of FIG. 5 best shows how ribbon 50 is now sandwiched between lock insert 12 and the lock housing 11. In the snapped position (as best seen in FIG. 7A), the tab 44 on the inside of right side wall 14 of the lock housing 11 has been slid into the channel 40 of the lock insert 12 so that the ledge 45 of the lock tab has been snapped over the ridge 41 of the lock insert 12 preventing the removal of the lock insert 12 from the lock housing 11. Also, in the locked position, the protrusion 25 in the lock chamber 18 will have pushed into the ribbon 50 and into the cavity 37 (as best seen in FIG. 5) of the lock insert to securely lock the ribbon 50 to the lock device 10.

With the security device 1 locked onto the merchandise item 100 it is now displayed for sale, at 1108. The brand plate 2, label 7 and ribbon, further brand the item 100, promote the manufacture of the item 100, display trademarks, information about the item 100 and the like. Eventually the merchandise item 100 will be sold, at 1110, to a customer with the security device 1 still attached to it.

If the item is returned, then the merchant can inspect the returned merchandise item before a refund is given to determine if the security device has been tampered with or if the ribbon has been cut, at 1112. First example, tampering may be evident when barb protrusion 225 of FIGS. 9 and 10 has cut into ribbon 50 in an attempt to remove it or if lock device 10 has significant damage from trying to pry lock insert 12 out of lock housing 11. If the ribbon was not cut and no tampering is evident, then a refund is given, at 1116.

However, if the ribbon has been cut or there is evidence of tampering, then a refund is not given, at 1114, and the item 100 is returned to the customer.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

What is claimed is:

1. A security device for detecting when the security device is removed from a merchandise item comprising:
a flexible ribbon adapted to be looped through a merchandise item having a first and second end;
a lock device adapted for locking onto the flexible ribbon including:
a lock insert;
a lock housing with a lock chamber adapted to receive and lock onto the lock insert when the lock insert is inserted into the lock chamber, wherein when the lock insert is locked into the housing the flexible ribbon is looped between the lock housing and the lock insert.

2. The security device for detecting when the security device is removed from the merchandise item of claim 1 further comprising:
a protrusion extending within the chamber adapted to push adjacent the flexible ribbon when the lock insert is locked into the lock housing further locking the ribbon to the lock device.

3. The security device for detecting when the security device is removed from the merchandise item of claim 2 further comprising:
a recess in the lock insert adapted to at least partially receive the protrusion when the lock insert is locked to the lock housing.

4. The security device for detecting when the security device is removed from the merchandise item of claim 1 wherein the lock housing and the lock insert are integrally formed.

5. The security device for detecting when the security device is removed from the merchandise item of claim 4 further comprising:
a flexible connector integrally between the lock housing and the lock insert.

6. The security device for detecting when the security device is removed from the merchandise item of claim 5 wherein flexible connector is elongated with a first end connected to the lock housing and a second end connected to the lock insert, wherein a center portion of the flexible connector between the first end and the second end is formed out of material so that center portion is thinner than the rest of the flexible connector.

7. The security device for detecting when the security device is removed from the merchandise item of claim 1 further comprising:
a branding plate for displaying information related to the merchandise item.

8. The security device for detecting when the security device is removed from the merchandise item of claim 1 wherein the lock device further comprises:
a barb adapted to cut into the ribbon when an attempt is made to pull it from the lock device when the lock insert and the lock housing are locked together.

9. The security device for detecting when the security device is removed from the merchandise item of claim 1 wherein the lock device and the lock housing are snap fitted together when locked together.

10. The security device for detecting when the security device is removed from the merchandise item of claim 1 wherein the lock housing further comprises:
a left side, a right side, a front side, a back side, and a top side that form the lock chamber, wherein the lock chamber is generally a rectangular shape.

11. The security device for detecting when the security device is removed from the merchandise item of claim 1 wherein the right side all of the lock housing further comprises:
a tab adapted to snap around a ridge formed in the tab insert to lock the lock housing and the lock insert together.

12. The security device for detecting when the security device is removed from the merchandise item of claim 1 wherein the lock housing and the lock insert are hingably connected together.

13. An anti-wardrobing device for attachment to a merchandise item comprising:
a ribbon with a first end and a second end adapted to be placed through the merchandise item; and
a lock adapted to be locked to the ribbon so that the ribbon is looped through the merchandise item and the lock so that the ribbon cannot be removed from the merchandise item without cutting the ribbon.

14. The anti-wardrobing device of claim 13 wherein the lock further comprises:
a first lock piece; and
a second lock piece that are locked together with the first end and the second end of the ribbon passing between the first lock piece and the second lock piece.

15. The anti-wardrobing device of claim 14 wherein the first lock piece further comprises:
a projection adapted to project adjacent the ribbon when the ribbon is locked between the first lock piece and the second lock piece.

16. The anti-wardrobing device of claim 14 wherein the first lock piece further comprises:
a barb adapted to tear the ribbon when it is pulled from the lock piece when the lock is locked to the ribbon.

17. The anti-wardrobing device of claim 14 wherein the first lock piece and the second lock piece are hingably connected together.

18. The anti-wardrobing device of claim 14 wherein the first lock piece further comprises a chamber adapted to receive the second lock member when the lock member is locked to the ribbon.

19. The anti-wardrobing device of claim 14 wherein the first lock piece and the second lock piece are snap-locked together.

20. The anti-wardrobing device of claim 13 wherein the first lock piece and the second lock piece are formed out of one piece of material.

21. The anti-wardrobing device of claim 13 further comprising:
a branding plate adjacent the lock adapted to display at least one from the group of: information about the merchandise item, branding of the merchandise item and no information
